(19) United States
(12) Patent Application Publication
(10) Pub. No.: US 2004/0206224 A1
(43) Pub. Date: Oct. 21, 2004

(54) Sound generating arrangement

(76) Inventor: Wayne Cohen, Bangkok (TH)

Correspondence Address: BAKER & BOTTS, 30 ROCKEFELLER PLAZA, NEW YORK, NY, 10112

(21) Appl. No.: 10/788,113

(22) Filed: Feb. 26, 2004

Related U.S. Application Data
(60) Provisional application No. 60/451,040, filed on Feb. 28, 2003.

(51) Int. Cl. G10D 13/08

(52) U.S. Cl. 84/410

(57) ABSTRACT

A container is provided with an external surface which has exterior ridges shaped such that sound is produced when a member slides across the ridges. The member is a scraper with one or more prongs. The container may also have a hollow cavity containing sound-producing pellets. The member is a scraper with one or more prongs. One arrangement for producing sound includes the container and the scraper. Another arrangement for producing sound includes the container, the scraper, and the sound-producing pellets in a hollow cavity in the container.

### RELATED APPLICATIONS

This application claims priority to U.S. Provisional Application Serial No. 60/451,040 filed Feb. 28, 2003, entitled “Musical Beverage Containers,” which is incorporated by reference herein in its entirety.

### FIELD OF THE INVENTION

The present invention relates to a sound generating arrangement, and in particular, to a container arrangement which includes external sections thereof which can be used to generate sound by striking portions of these sections. For example, the arrangement can be a musical instrument in the form of a beverage container, such as a bottle or a can.

### BACKGROUND OF THE INVENTION

Previously, there have been musical instruments such as maracas, bongos, and whistles which have been used to generate sound or noise. These devices have been used as noise makers. However, there are no noise makers which can be used as a container, while having an external portion with ridges that are configured to make a sound when they are stricken. Such devices would allow various items to be placed therein (e.g., pellets, stones, etc.) so as to generate noise while the container is stirred or shaken, while a scraper can be used to strike the ridges of the container. In this manner, the noise maker can be used as a maraca shaker, and at the same time, the external part thereof may be utilized to make sound.

### OBJECTS AND SUMMARY OF THE INVENTION

One of the objects of the present invention is to provide a container arrangement, at least a portion of which is adapted to be stricken so as to generate a sound, and preferably a musical sound. Such arrangements can be used as promotional items for a nightclub or other establishment which serves beverages and also provides musical entertainment.

These objects can be achieved by providing an arrangement. Such arrangement produces sound, and includes a scraper and a container with an external surface having exterior ridges, the exterior ridges being shaped to produce a plurality of sounds when the scraper is slid across the ridges. The arrangement can also include an internal portion including at least one hollow cavity, such that the at least one hollow cavity contains pellets. When the container is stirred or shaken, the pellets strike the inner portion so as to produce a sound. The scraper can be detachably attached to the container by press fitting the scraper into a top bore of the container. The scraper may rest in a top bore of the container. The scraper can be collapsible, so as to be stored inside or outside of the container.

### BRIEF DESCRIPTION OF THE DRAWINGS

FIG. 1 is a front view of one exemplary embodiment of a bottle in accordance with the invention.

FIG. 2 is a side view of the FIG. 1 bottle.

FIG. 3 is a rear view of the FIG. 1 bottle.

FIG. 4 is a front view of a guiro scraper.

FIG. 5 is a top view of the FIG. 4 scraper.

FIG. 6 is a side view of FIG. 4 scraper.

FIG. 7 is a bottom view of FIG. 4 scraper.

FIG. 8 is a front assembly view of the bottle of FIG. 1 with the guiro scraper of FIG. 4 assembled.

FIG. 9 is a top view of the assembly shown in FIG. 8.

FIG. 10 is a side view of the assembly shown in FIG. 8.

FIG. 11 is a rear view of the assembly shown in FIG. 8.

FIG. 12 is a front view of an alternate embodiment of a can in accordance with the invention.

FIG. 13 is a top view of the FIG. 12 can.

FIG. 14 is a side view of the FIG. 12 can.

FIG. 15 is a rear view of the FIG. 12 can.

### DETAILED DESCRIPTION OF THE INVENTION

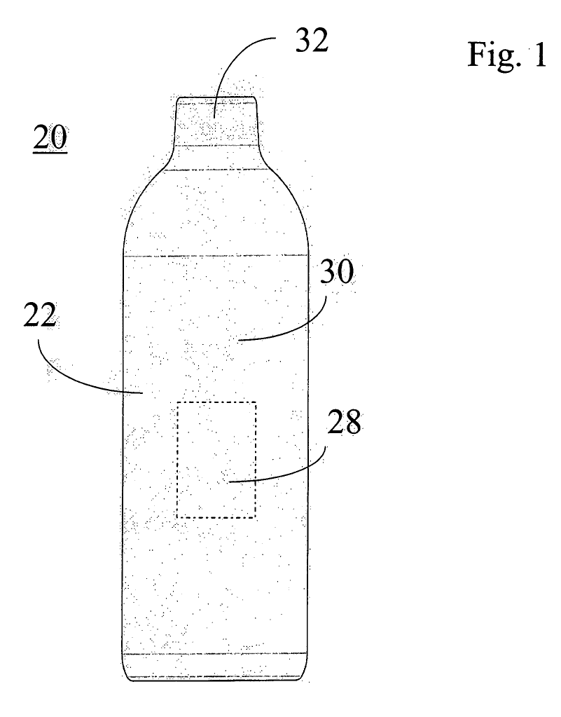

Referring to FIGS. 1-3, there is depicted a first embodiment of the invention. The embodiment in the form of a bottle 20 which is formed with a main member 22 having a side surface 24. The member 22 may be fabricated of plastic, such as Polyethylene Terephthalate, for example by blow molding. The side surface 24 is integrally formed into member 22 and includes ridges 26.

Preferably, a region 28 is provided on the front surface 30 of the member 22 to receive a printed or attached label consisting of an advertisement for a beverage or other item or service. Alternatively, the identification of the establishment, such as a nightclub, may be printed thereon.

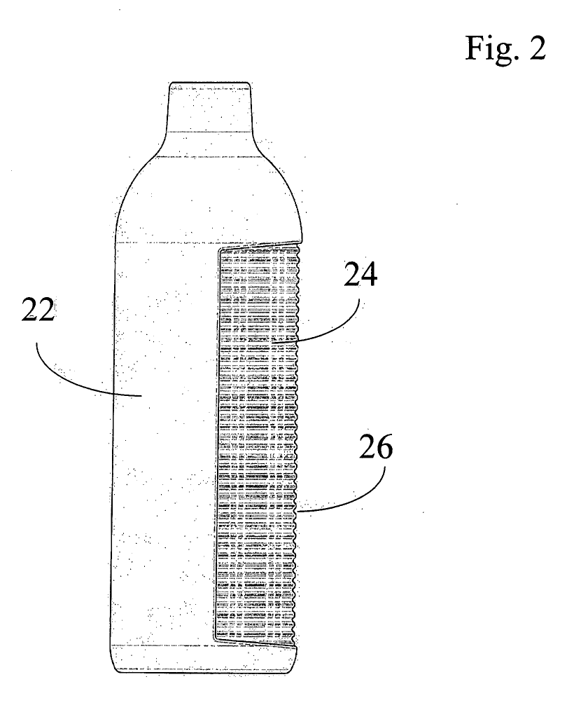

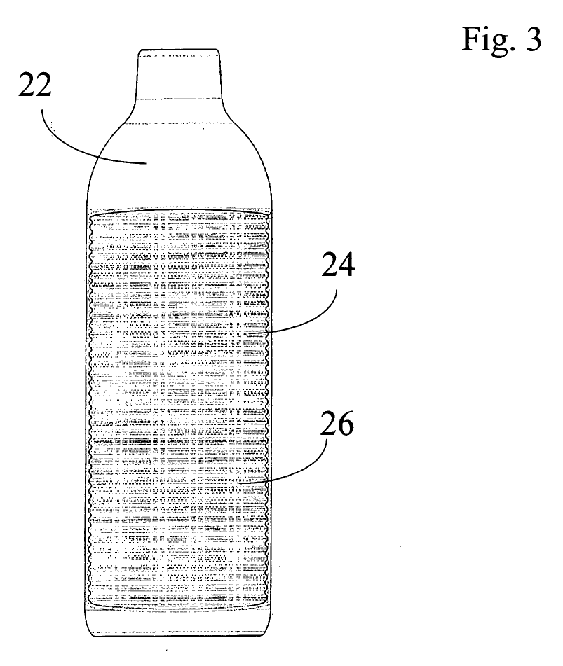

Referring to FIGS. 2 and 3 the side surface 24 has exterior ridges 26 which are intended to be used as a guiro for purposes of music or amusement. The overall shape of the bottle 20 may simulate a beverage bottle. For example, the overall bottle 20 shape may simulate a rum bottle or a soft drink bottle, such as cola.

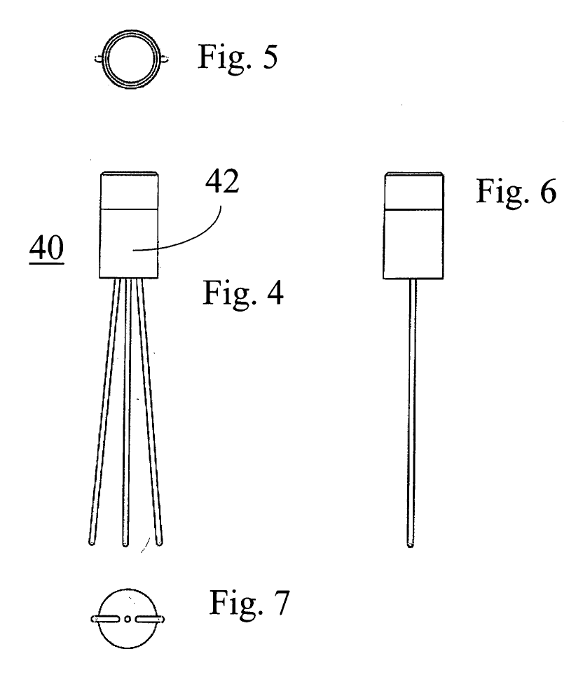

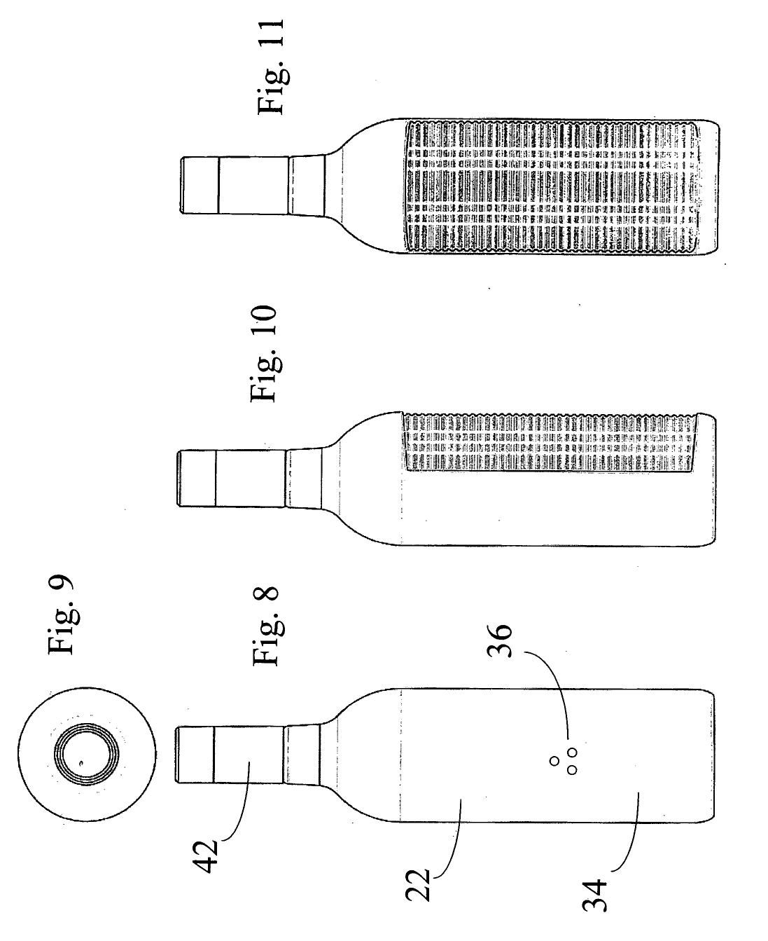

FIGS. 4-7 show a scraper 40 having prongs and an enlarged end 42 to be held by the user for playing the guiro-bottle of the exemplary embodiment of the present invention. The scraper 40 may be fabricated of plastic, such as polypropylene, for example by injection molding. In one embodiment of the present invention, the enlarged end 42 is typically in the form of a bottle top or cork which allows the scraper 40 to be neatly placed in the bore 32 of the member 22 for storage and aesthetic enhancement, as is depicted in FIGS. 8-11.

Within the cavity 34 of the member 22, there may be placed steel shot 36 or other sound producing pellets. In this event the hollow member may be closed, for example by a plug.

It is contemplated that many versions or embodiments of the invention may be provided. In a first exemplary embodiment the simulated bottle 20 acts as both a guiro and a shaker instrument and includes the ridges 26 on the side surface 24 for providing a guiro sound and the shot 36 within the member for providing a shaker sound. In a second exemplary embodiment, the shot 36 may not be provided, and the bottle 20 may be usable as a guiro only.

In an alternate exemplary embodiment of the present invention, the scraper 40 is retained in the bore 32 of the member 22 using snaps (not shown), as depicted in FIGS. 8-11.

In yet another exemplary embodiment of the present invention, the scraper 40 can be retained via a press fit in the bore 32 in the member 22, similar to a traditional cork.

In still another exemplary embodiment of the present invention, the scraper 40 is not affixed to the member 22 at all, but it may merely be resting in the bore 32 or held by a releasable adhesive or tape.

In all the aforementioned embodiments according to the present invention, the bore 32 may be sealed or open notwithstanding the placement of the scraper 40. The seal may retain the steel shot 36 or enhance musical amusement. The bore 32 may be open to allow for stirring of the shot 66.

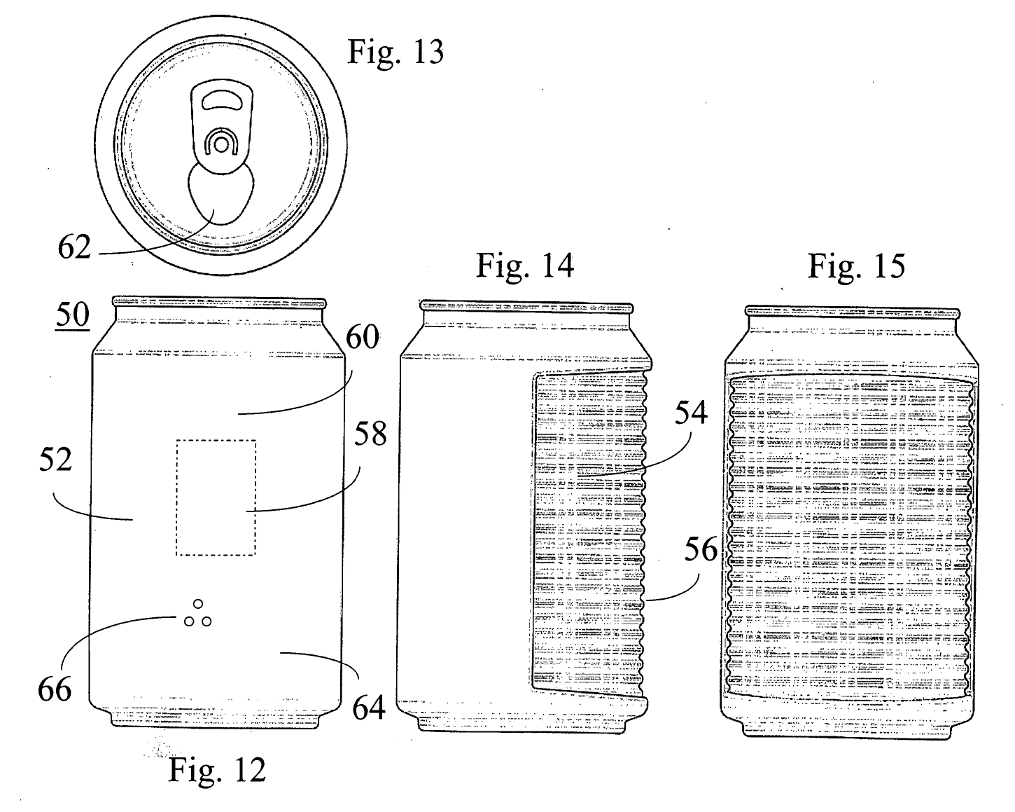

Referring to FIGS. 12-15 there is depicted another embodiment of the invention. The exemplary embodiment is in the form of a can 50 which is formed with a main member 52 having a side surface 54. The member 52 may be fabricated of plastic, by blow molding, or metal, such as aluminum or tin plated steel. The side surface 54 is integrally formed into member 52 and includes ridges 56. Each ridge 56 is designed to make a specific sound when the scraper 40 is slid across the ridge 56.

Preferably, a region 58 is provided on a front surface 60 of the member 52 to receive a printed or attached label consisting of an advertisement for a beverage or other item or service. Alternatively the identification of the establishment, such as a nightclub, may be printed thereon.

Referring to FIG. 14 the side surface 54 has exterior ridges 56 which are intended to be used as a guiro for purposes of music or amusement.

The scraper 40 used with the can 50 may be similar to the scraper 40 used with the bottle 20 and may be retained to the can 50 by similar means as that used to affix it to the bottle 20. The bore 62 in the can 50 may serve a similar purpose as in the embodiments disclosed when the scraper 40 is used with the bottle 20.

In another exemplary embodiment of the present invention, the scraper 40 is collapsible so that it can be stored inside or outside the can 50 neatly.

Within the cavity 64 of the member 52 there may be placed steel shot 66 or other sound producing pellets. In this event the hollow member may be closed, for example by a plug. Alternatively, the hollow member may be sealed similar to an unopened beverage can. Alternatively, it may be unsealed so the scraper 40 can be used to stir the shot 66.

It is contemplated that many exemplary versions or embodiments of the present invention may be provided. In one exemplary embodiment, the simulated can 50 acts as both a guiro and a shaker or stirring instrument and includes the ridges 56 on the side surface 54 for providing a guiro sound and the shot 66 within the member 52 for providing a shaker sound or stirring sound. In another exemplary embodiment, the shot 66 may not be provided, and the can 50 may be usable as a guiro only.

What is claimed is:

1. An arrangement for producing sound comprising a scraper and a container with an external surface having exterior ridges, the exterior ridges being shaped to produce a plurality of sounds when the scraper is slid across the ridges.

2. The arrangement for producing sound of claim 1, further comprising an internal portion including at least one hollow cavity, wherein the at least one hollow cavity contains pellets.

3. The arrangement for producing sound of claim 2, wherein, when the container is stirred or shaken, the pellets strike the inner portion so as to produce a sound.

4. The arrangement of claim 1, wherein the scraper is detachably attached to the container by press fitting the scraper into a top bore of the container.

5. The arrangement of claim 1, wherein the scraper rests in a top bore of the container.

6. The arrangement of claim 1, wherein the scraper is collapsible, so as to be stored inside or outside of the container.

7. The arrangement of claim 1, wherein the scraper has at least one prong.

8. A container comprising an external surface having exterior ridges, the exterior ridges being shaped to produce a plurality of sounds when a scraper is slid across the ridges.

9. The container of claim 8, further comprising an internal portion including at least one hollow cavity wherein the at least one hollow cavity contains pellets.

10. The container of claim 9, wherein, when the container is shaken or stirred, the pellets strike the inner portion so as to produce a sound.

11. The container of claim 9, wherein the hollow cavity is sealable.

12. The container of claim 8, wherein each ridge is designed to make at least one specific sound when the scraper is slid across the ridge.
